(19) United States
(12) Patent Application Publication
(10) Pub. No.: US 2025/0306946 A1
(43) Pub. Date: Oct. 2, 2025

(54) INDEPENDENT PROGRESS OF LANES IN A VECTOR PROCESSOR

(71) Applicant: Advanced Micro Devices, Inc., Santa Clara, CA (US)

(72) Inventors: Joseph L. Greathouse, Austin, TX (US); Christopher J. Brennan, Holden, MA (US); Sean Keely, Austin, TX (US)

(21) Appl. No.: 18/618,939

(22) Filed: Mar. 27, 2024

(51) Int. Cl. G06F 9/38; G06F 9/30; G06F 9/32

(52) U.S. Cl. CPC G06F 9/38885

(57) ABSTRACT

An apparatus and method for efficiently processing instructions in hardware parallel execution lanes. In various implementations, a computing system includes a processing circuit that uses a single instruction multiple data (SIMD) circuit that maintains multiple program counter values for multiple parallel lanes of execution. If a divergent point has been reached in the application, then the SIMD circuit generates a lane selecting identifier specifying one of the parallel lanes of execution that remains active to execute the taken path of the divergent point. The SIMD circuit continues executing with each of the parallel lanes of execution with a program counter that matches a program counter of the parallel lane of execution pointed to by the lane selecting ID. The SIMD circuit switches lanes from being inactive to active after a threshold amount of time has elapsed. The SIMD circuit also performs other steps to increase memory-level parallelism.

### BACKGROUND

### Description of the Relevant Art

The parallelization of tasks is used to increase the throughput of computing systems. To this end, compilers extract parallelizable tasks from applications to execute in parallel on the system hardware. To increase parallel execution on the hardware, a parallel data processing circuit(s) can be used that includes multiple parallel execution lanes, such as in a single instruction multiple data (SIMD) micro-architecture. This type of micro-architecture provides higher instruction throughput for parallel data applications than a general-purpose micro-architecture. Some examples of tasks that benefit from the SIMD micro-architecture include video graphics rendering, cryptography, and machine learning data models. Tasks that benefit from the SIMD micro-architecture are used in a variety of applications in a variety of fields such as medicine, science, chemistry, engineering, social media, finance, and so on.

SIMD circuits of a parallel data processing circuit (e.g., in a GPU) frequently have a single program counter (PC) register and multiple lanes of execution. To allow compilers to map “single instruction multiple threads” (SIMT) programming models to the multiple lanes of execution, SIMD circuits use a per-lane predicate mask to control which lanes are active. Each thread is capable of branching in a different direction than another concurrently executing thread, and all of the multiple lanes of execution utilize the single PC register of the SIMD circuit. It is the compiler's responsibility to set this predicate mask at control flow points in the parallel data application to deactivate lanes that are not executing the currently selected control path.

One problem with the above approach that uses a single program counter for multiple lanes is that it is possible to deadlock a parallel data application utilizing multiple threads. In addition, the execution of separate branches is serialized. This can reduce the amount of memory-level parallelism in the application and reduce performance. These problems can be resolved by modifying the SIMD circuit to independently fetch different instructions from each of the multiple lanes of execution in each clock cycle. However, such an approach would significantly complicate the hardware, increase on-die area, and increase power consumption.

In view of the above, efficient methods and apparatuses for efficiently processing instructions in hardware parallel execution lanes within a processing circuit are desired.

### BRIEF DESCRIPTION OF THE DRAWINGS

FIG. 1 is a generalized diagram of a single instruction multiple data (SIMD) circuit that efficiently processes instructions in hardware parallel execution lanes.

FIG. 2 is a generalized block diagram of a method for efficiently processing instructions in hardware parallel execution lanes.

FIG. 3 is a generalized block diagram of state information used for efficiently processing instructions in hardware parallel execution lanes.

FIG. 4 is a generalized block diagram of a method for efficiently processing instructions in hardware parallel execution lanes.

FIG. 5 is a generalized block diagram of a method for efficiently processing instructions in hardware parallel execution lanes.

FIG. 6 is a generalized diagram of an apparatus that efficiently processes instructions in hardware parallel execution lanes.

FIG. 7 is a generalized block diagram of a method for efficiently processing instructions in hardware parallel execution lanes.

FIG. 8 is a generalized diagram of an apparatus that efficiently processes instructions in hardware parallel execution lanes.

FIG. 9 is a generalized diagram of an apparatus that efficiently processes instructions in hardware parallel execution lanes.

FIG. 10 is a generalized diagram of vector registers used to efficiently process instructions in hardware parallel execution lanes.

FIG. 11 is a generalized diagram of vector registers used to efficiently process instructions in hardware parallel execution lanes.

FIG. 12 is a generalized block diagram of a method for efficiently processing instructions in hardware parallel execution lanes.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for efficiently processing instructions in hardware parallel execution lanes are contemplated. In various implementations, a computing system includes a parallel data processing circuit that includes one or more independent lane progressing single instruction multiple data (SIMD) circuits. The SIMD circuit includes multiple parallel lanes of execution for executing instructions of a parallel data application. As disclosed, the SIMD circuit maintains multiple program counter values for the multiple parallel lanes of execution, rather than maintaining a single program counter value for all the multiple parallel lanes of execution. By maintaining separate program counters for each lane, the lanes may progress independent of one another in the presence of a divergent point. As used herein, the term “divergent point” refers to an instruction in an application that is a conditional control flow transfer instruction in the application such as a conditional branch instruction and a conditional case statement. The divergent point (conditional control flow transfer instruction) in the application causes control flow across the multiple parallel lanes of execution of the SIMD circuit to diverge and separate from one another.

If a divergent point has been reached in the application, then the SIMD circuit generates an indication specifying one of the multiple paths provided by execution of the divergent point. The SIMD circuit generates a lane selecting identifier (ID) specifying one of the parallel lanes of execution that remains active to execute the specified path. In some implementations, the specified path is a taken path of the divergent point in contrast to the not-taken path. In other implementations, execution begins with the non-taken path and the specified path is the not-taken path.

The SIMD circuit continues executing with each of the parallel lanes of execution with a program counter value that matches a program counter value of the parallel lane of execution pointed to by the lane selecting ID. These parallel lanes of execution continue to be active, whereas the other parallel lanes of execution are inactive. The SIMD circuit generates an indication specifying the lane selecting ID should be updated based on one of multiple conditions. An example of the conditions includes the SIMD circuit measures elapsed time since reaching the divergent point. If the elapsed time has reached the threshold, then the SIMD circuit updates the lane selecting ID to specify one of the parallel lanes of execution that has remained inactive. Other examples of the conditions are execution of a particular instruction, such as one of a variety of wait instructions, an indication of a trap or an interrupt has occurred, an indication of an event such as an instruction cache miss, a data cache miss, a translation lookaside buffer (TLB) cache miss, and so forth. In an implementation, the even numbered parallel lanes of execution have been active and the odd numbered parallel lanes of execution have been inactive.

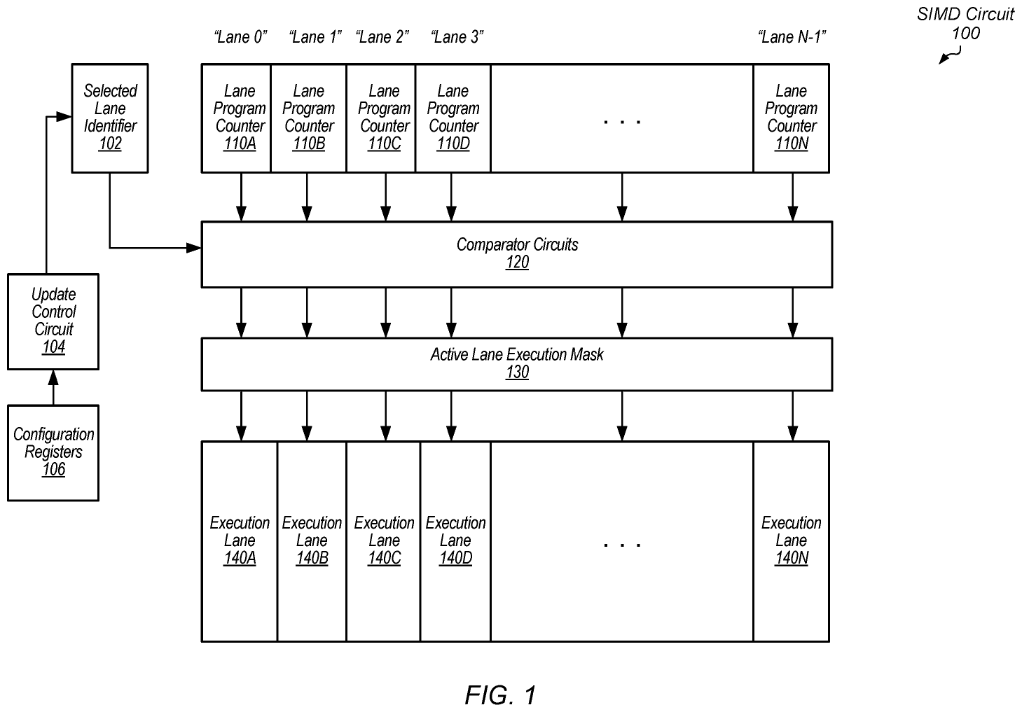

Therefore, the SIMD circuit updates the lane selecting ID to specify one of the odd numbered parallel lanes of execution that has remained inactive. The SIMD circuit also performs other steps to increase memory-level parallelism. Further details of these techniques to efficiently process instructions in hardware parallel execution lanes are provided in the following description of FIGS. 1-9.

Turning now to FIG. 1, a generalized diagram is shown of single instruction multiple data (SIMD) circuit 100 supporting independent lane progression that efficiently processes instructions in hardware parallel execution lanes. In various implementations, independent lane progressing SIMD circuit 100 is instantiated multiple times within a parallel data processing circuit that uses a parallel data micro-architecture, such as a single instruction multiple data (SIMD) micro-architecture, providing high instruction throughput for a computationally intensive task of a highly parallel and wide data application. In some implementations, independent lane progressing SIMD circuit 100 (or SIMD circuit 100) is instantiated multiple times within a graphics processing unit (GPU). These applications processed by the parallel data processing circuit use parallelized tasks for at least video graphics, scientific and engineering fields, medical field, and business (finance) field. In some cases, these applications perform the steps of neural network training and inference. As shown, SIMD circuit 100 includes a selected lane identifier (ID) 102, update control circuit 104, configuration registers 106, multiple lane program counters 110A-110N, comparator circuits 120, active lane execution mask 130, and execution lanes 140A-140N.

In various implementations, the data flow of SIMD circuit 100 is pipelined and the parallel execution lanes 140A-140N operate in lockstep. In various implementations, the circuitry of each of the execution lanes 140B-140N is an instantiated copy of the circuitry of execution lane 140A. Execution lane 140A includes circuitry for arithmetic logic units (ALUs) that perform integer arithmetic, floating-point arithmetic, Boolean logic operations, branch condition comparisons, and so forth. Each of the ALUs within a given row across the execution lanes 140A-140N includes the same circuitry and functionality, and operates on the same instruction, but different data, such as a different data item, associated with a different thread. Pipeline registers are used for storing intermediate results.

A particular combination of the same instruction and a particular data item of multiple data items is referred to as a “work item.” A work item is also referred to as a thread. The multiple work items (or multiple threads) are grouped into thread groups, where a “thread group” is a partition of work executed in an atomic manner. In some implementations, a thread group includes instructions of a function call that operates on multiple data items concurrently. Each data item is processed independently of other data items, but the same sequence of operations of the subroutine is used. As used herein, a “thread group” is also referred to as a “work block” or a “wavefront.” Tasks performed by execution lanes 140A-140N can be grouped into a “workgroup” that includes multiple thread groups (or multiple wavefronts). The hardware, such as circuitry, of a scheduler (not shown) of SIMD circuit 100 divides the workgroup into separate thread groups (or separate wavefronts) and assigns the wavefronts to be dispatched to execution lanes 140A-140N.

A scheduler, a dispatch circuit, one or more caches, other control circuitry, storage elements, such as pipeline registers, a vector register file, computation units with arithmetic logic unit (ALU) circuits, clock generating circuitry, and so forth are not shown for ease of illustration. Although a particular number of execution lanes 140A-140N and corresponding lane program counters 110A-110N are shown, in other implementations, another number of these components is used. Although SIMD circuit 100 includes multiple lane program counters 110A-110N, in various implementations, an instruction cache for SIMD circuit 100 utilizes a single read port for receiving a single program counter (PC) value.

Each of the lane program counters 110A-110N and the selected lane identifier 102 are stored in storage elements such as registers or flip flop circuits. Comparator circuits 120 receives the multiple lane program counters 110A-110N and additionally receives the selected lane identifier 102. Selected lane identifier 102 stores an identifier that specifies one of the execution lanes 140A-140N. In an implementation, lane program counters 110A-110N includes 32 program counters and selected lane identifier 102 is a 5-bit value that specifies one of the 32 program counters. Comparator circuits 120 includes multiplexing circuitry or other selection circuitry that reads the program counter of the 32 program counters specified by the value stored in selected lane identifier 102 and compares the read-out program counter to the other 31 program counter values. Comparator circuits 120 generates multiple indications, each specifying whether a corresponding one of the lane program counters 110A-110N stores a program counter value that matches the program counter value stored in the lane chosen by the value stored in selected lane identifier 102. The resulting indications provide the active lane execution mask 130.

Comparator circuits 120 generates active lane execution mask 130 indicating which lanes of execution lanes 140A-140N are active for processing tasks. In some implementations, the active lane execution mask 130 is a bit mask where a bit position of each asserted bit indicates a lane of execution lanes 140A-140N that is active, and a bit position of each negated bit indicates a lane of execution lanes 140A-140N that is inactive. In other implementations, asserted bits indicate inactive lanes and negated bits indicate active lanes. The control flow across the execution lanes 140A-140N of SIMD circuit 100 diverge and separate from one another when the SIMD circuit 100 reaches a divergent point (conditional control flow transfer instruction) in an application being executed by the SIMD circuit 100. Examples of the divergent point (conditional control flow transfer instruction) are a conditional branch instruction and a conditional case statement.

The conditional branch instruction has an if-elseif-else construct or an if-else construct and relies on the outcome of an expression using the value of a variable stored in a register to change the control flow of the application. The conditional case statement can also be referred to as a switch statement. The conditional case statement also relies on the outcome of an expression using the value of a variable stored in a register to change the control flow of the application. The conditional case statement can have an if-elseif-else construct, an if-elseif-elseif-else construct, or another similar construct. In contrast, an unconditional control flow transfer instruction, such as a jump instruction, unconditionally transfers the control flow to another path that includes a basic block that is not the next subsequent basic block of the application. The unconditional control flow transfer instruction (jump instruction) does not rely on the outcome of an expression using the value of a variable stored in a register to change the control flow of the application. The software programmer inserts a divergent point at the end of a basic block to conditionally transfer control flow to additional instructions in a separate basic block located elsewhere in the application before transferring control to the next subsequent basic block.

Each of the execution lanes 140A-140N has a corresponding one of the lane program counters 110A-110N, which appears to provide instruction fetch independence from any other lane of execution lanes 140A-140N. However, selected lane identifier 102 indicates which lanes of the execution lanes 140A-140N are activated. In an implementation, instructions of a parallel data application cause each even numbered lane of execution lanes 140A-140N to be activated and each odd numbered lane of execution lanes 140A-140N to be deactivated. For example, the instructions of the parallel data application cause the even numbered lanes of execution lanes 140A-140N to pass a test such as a taken result of a branch instruction, whereas the instructions of the parallel data application cause the odd numbered lanes of execution lanes 140A-140N to fail the test such as a not-taken result of the branch instruction.

Selected lane identifier 102 stores a value indicating lane 0 of the 32 lanes 0-31, and this value is an even numbered lane. Due to the taken result of the branch instruction, each of the even numbered lanes stores the same program counter value in a corresponding one of the lane program counters 110A-110N as the program counter value stored in lane program counter 110A corresponding to lane 0. In contrast, due to the not-taken result of the branch instruction, each of the odd numbered lanes stores a different program counter value in a corresponding one of the lane program counters 110A-110N than the program counter value stored in lane program counter 110A corresponding to lane 0.

In some implementations, update control circuit 104 generates an indication specifying a particular period of time has elapsed, such as a particular count of clock cycles, and as a result, update control circuit 104 updates the value stored in selected lane identifier 102. In an implementation, update control circuit 104 accesses a programmable configuration register of configuration registers 106 that stores a threshold count of clock cycles that indicates the period of time. In an example, the period of time is 5 clock cycles. After update control circuit 104 generates an indication specifying that 5 clock cycles have elapsed, update control circuit 104 updates the value stored in selected lane identifier from 0 to 1. Therefore, the odd numbered lanes of execution lanes 140A-140N become activated and the even numbered lanes of execution lanes 140A-140N become deactivated.

In another implementation, update control circuit 104 generates an indication specifying a particular number of instructions has been executed, and as a result, update control circuit 104 updates the value stored in selected lane identifier 102. Update control circuit 104 accesses a programmable configuration register of configuration registers 106 that stores a threshold count of instructions. In an example, the count of instructions is 8 instructions. After update control circuit 104 generates an indication specifying that 8 instructions have been executed, update control circuit 104 updates the value stored in selected lane identifier from 0 to 1. Software, such as the if-then-else construct and other conditional control instructions of the parallel data application, no longer is the only source updating the value of the program counter being sent to the instruction cache. Rather, the hardware, such as circuitry, of SIMD circuit 100 can also update the value of the program counter being sent to the instruction cache. SIMD circuit 100 can execute a new vector branch instruction that allows each of the lane program counters 110A-110N to update its stored program counter value although a single program counter value is still being sent to the instruction cache for an instruction fetch operation.

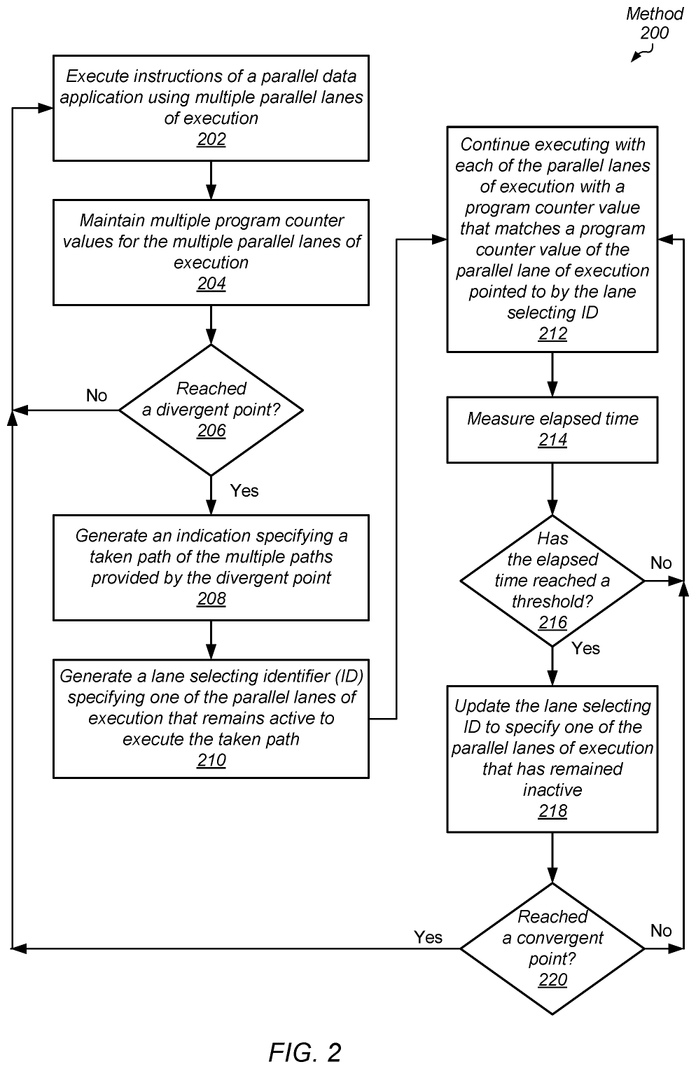

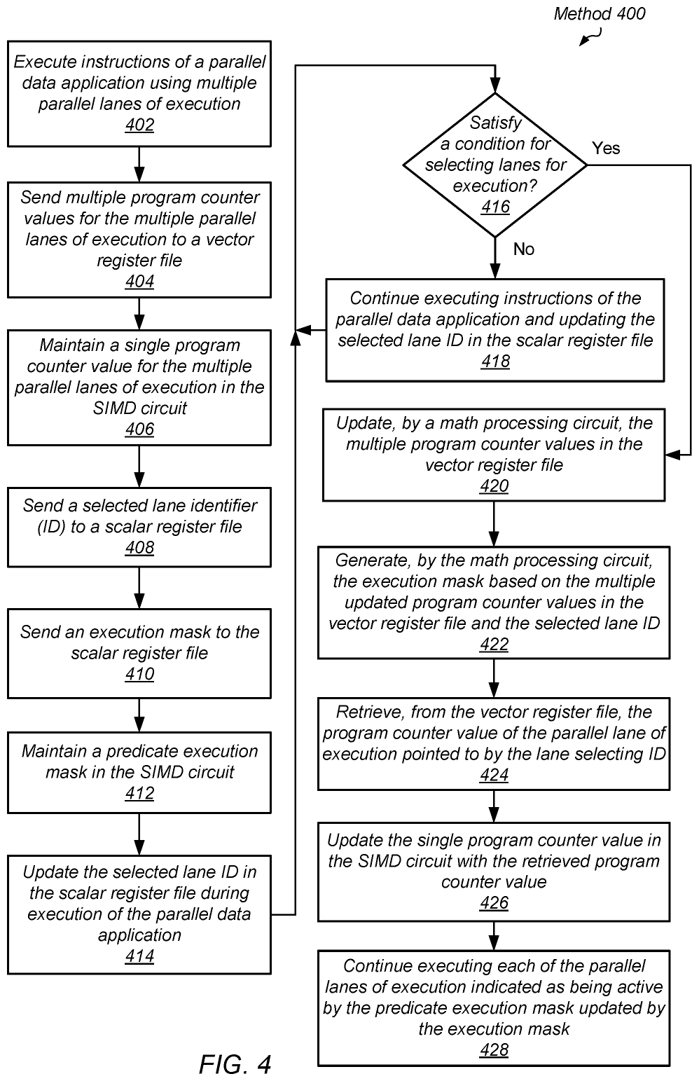

Referring to FIG. 2, a generalized diagram is shown of a method 200 for efficiently processing instructions in hardware parallel execution lanes. For purposes of discussion, the steps in this implementation (as well as FIGS. 4-5 and 7) are shown in sequential order. However, in other implementations some steps occur in a different order than shown, some steps are performed concurrently, some steps are combined with other steps, and some steps are absent.

A single instruction multiple data (SIMD) circuit supporting independent lane progression executes instructions of a parallel data application using multiple parallel lanes of execution (block 202). The SIMD circuit supporting independent lane progression maintains multiple program counter values for the multiple parallel lanes of execution (block 204). If a divergent point has not yet been reached (“no” branch of the conditional block 206), then control flow of method 200 returns to block 202 where the SIMD circuit executes instructions of the parallel data application using multiple parallel lanes of execution. Otherwise, if a divergent point has been reached (“yes” branch of the conditional block 206), then the SIMD circuit generates an indication specifying a taken path of the multiple paths provided by the divergent point (block 208). The SIMD circuit generates a lane selecting identifier (ID) specifying one of the parallel lanes of execution that remains active to execute the taken path (block 210).

The SIMD circuit continues executing with each of the parallel lanes of execution with a program counter value that matches a program counter value of the parallel lane of execution pointed to by the lane selecting identifier (ID) (block 212). These parallel lanes of execution continue to be active, whereas the other parallel lanes of execution are inactive. A control circuit of the SIMD circuit measures elapsed time (block 214). In various implementations, the control circuit measures elapsed time since reaching the divergent point. The control circuit measured elapsed time by updating a count of clock cycles or by updating a count of instructions that have been issued or executed. If the elapsed time has not yet reached a threshold (“no” branch of the conditional block 216), then control flow of method 200 returns to block 212 where the SIMD circuit continues executing with each of the active parallel lanes of execution.

If the elapsed time has reached the threshold (“yes” branch of the conditional block 216), then the control circuit of the SIMD circuit updates the lane selecting ID to specify a different parallel lane of execution (block 218). In some implementations, the different parallel lane of execution uses a different program counter value from the program counter value that is currently being used. In various implementations, the different lane selecting ID specifies one of the parallel lanes of execution that has remained inactive. In an implementation, the even numbered parallel lanes of execution have been active and the odd numbered parallel lanes of execution have been inactive. Therefore, in an implementation, the control circuit updates the lane selecting ID to specify one of the odd numbered parallel lanes of execution that has remained inactive. If a convergent point has not yet been reached (“no” branch of the conditional block 220), then control flow of method 200 returns to block 212 where the SIMD circuit continues executing with each of the active parallel lanes of execution.

If a convergent point has been reached (“yes” branch of the conditional block 220), then control flow of method 200 returns to block 202 where the SIMD circuit executes instructions of a parallel data application using the multiple parallel lanes of execution. It is noted that in addition to measuring elapsed time upon reaching a divergent point, the SIMD circuit generates an indication specifying the lane selecting ID should be updated based on other types of multiple conditions. Other examples of the conditions are execution of a particular instruction, such as one of a variety of wait instructions, an indication of a trap or an interrupt has occurred, an indication of an event such as an instruction cache miss, a data cache miss, a translation lookaside buffer (TLB) cache miss, and so forth.

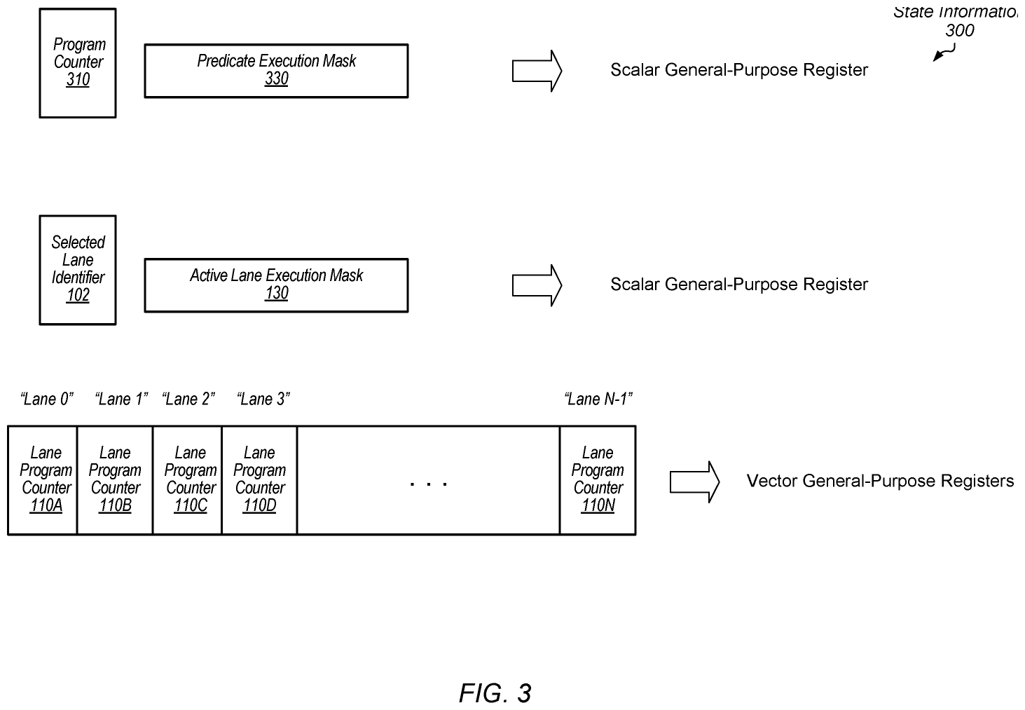

Turning now to FIG. 3, a generalized diagram is shown of state information 300 used for efficiently processing instructions in hardware parallel execution lanes. Circuitry and components previously described are numbered identically. As shown, in some implementations, the multiple lane program counters 110A-110N can be stored in a vector register file, rather than maintained in the independent lane progressing SIMD circuit (or SIMD circuit) such as SIMD circuit 100 (of FIG. 1).

In an implementation, each of the lane program counters 110A-110N has a data size of 64 bits and the lane program counters 110A-110N includes 32 program counter values. In this implementation, the lane program counters 110A-110N require 2,048 bits (64 bits per program counter value×32 program counter values is 2,048 bits). Compared to a single program counter value, such as program counter 310, with a data size of 64 bits, the required on-die area has increased from supporting 64 storage elements to supporting 2,048 storage elements. In addition, when the selected lane identifier 102 has a data size of 5 bits (due to the lane program counters 110A-110N includes 32 program counter values) and the active lane execution mask 130 has a data size of 32 bits (due to the lane program counters 110A-110N includes 32 program counter values), the SIMD circuit requires 37 additional storage elements. Therefore, in various implementations, the SIMD circuit stores the selected lane identifier 102 and the active lane execution mask 130 in the scalar register file.

The instruction fetch circuit of the SIMD circuit is unable to access the vector register file each clock cycle without increasing the number of read ports and write ports of the vector register file. Therefore, the SIMD circuit stores the program counter 310 and the predicate execution mask 330 in a scalar register file, and the SIMD circuit updates values for program counter 310 and the predicate execution mask 330 each clock cycle. During execution of a parallel data application, the number of clock cycles that elapse before a divergent point is reached can be one thousand clock cycles. Therefore, frequent updates are not required for the lane program counters 110A-110N. A divergent point occurs within straight line code or a loop of the parallel data application when the instructions of the parallel data application include an if-elseif-else construct, an if-else construct, a case construct, and so forth. Across the different lanes of the execution lanes 140A-140N (of FIG. 1), a lane can have a different target program counter value than another lane of the execution lanes 140A-140N due to differing results for a control flow transfer instruction. Examples of the control flow transfer instruction are a branch instruction, a jump instruction, and a case statement.

Rather than rely on adding hardware to the instruction fetch circuitry of the SIMD circuit, in some implementations, the SIMD circuit relies on already-present hardware such as a math processing circuit. The math processing circuit already includes wide selection circuitry and wide comparator circuitry that can be used to provide the functionality of comparator circuits 120 (of FIG. 1). In some implementations, the math processing circuit is a dedicated functional unit in addition to the execution lanes 140A-140N. In other implementations, the math processing circuit is implemented by ALUs across the execution lanes 140A-140N. For example, SIMD circuit 100 (of FIG. 1) already includes hardware, such as a wide comparator circuit, to execute vector comparison instructions. In addition, SIMD circuit 100 already includes wide selection circuitry to execute instructions that select a single element of multiple elements of a vector and store the selected single element in the scalar register file. Therefore, the math processing circuit becomes unavailable for other instructions of the parallel data application during a short period of time while the math processing circuit supports the instruction fetch circuit of the SIMD circuit.

When a divergent point is reached, the SIMD circuit updates, via the math processing circuit, the multiple program counter values in the vector register file. The math processing circuit generates the execution mask based on the multiple updated program counter values in the vector register file and the selected lane identifier. The SIMD circuit retrieves, from the vector register file, the program counter value of the parallel lane of execution pointed to by the selected lane ID 102. The SIMD circuit updates the single program counter value in the SIMD circuit with the retrieved program counter value. The SIMD circuit continues executing each of the parallel lanes of execution indicated as being active by the predicate execution mask updated by the execution mask.

Turning now to FIG. 4, a generalized diagram is shown of a method 400 for efficiently processing instructions in hardware parallel execution lanes. A single instruction multiple data (SIMD) circuit supporting independent lane progression executes instructions of a parallel data application using multiple parallel lanes of execution (block 402). The SIMD circuit supporting independent lane progression sends multiple program counter values for the multiple parallel lanes of execution to a vector register file (block 404). The SIMD circuit maintains a single program counter value for the multiple parallel lanes of execution (block 406). The SIMD circuit sends a selected lane identifier (ID) to a scalar register file (block 408). The SIMD circuit sends an execution mask to the scalar register file (block 410).

The SIMD circuit maintains a predicate execution mask (block 412). The SIMD circuit updates the selected lane ID in the scalar register file during execution of the parallel data application (block 414). In some implementations, a condition for selecting lanes for execution is satisfied when a divergent point is reached, or the SIMD circuit generates an indication that a threshold period of time has elapsed since the divergent point was reached. If the condition for selecting lanes for execution is not satisfied (“no” branch of the conditional block 416), then the SIMD circuit continues executing instructions of the parallel data application and updating the selected lane ID in the scalar register file (block 418). However, if the condition for selecting lanes for execution is satisfied (“yes” branch of the conditional block 416), then the SIMD circuit updates, by a math processing circuit, the multiple program counter values in the vector register file (block 420). In various implementations, the math processing circuit already exists for executing instructions of the parallel data application and no additional hardware is provided in the SIMD circuit.

The math processing circuit generates the execution mask based on the multiple updated program counter values in the vector register file and the selected lane identifier (block 422). The SIMD circuit retrieves, from the vector register file, the program counter value of the parallel lane of execution pointed to by the selected lane ID (block 424). The SIMD circuit updates the single program counter value in the SIMD circuit with the retrieved program counter value (block 426). The SIMD circuit continues executing each of the parallel lanes of execution indicated as being active by the predicate execution mask updated by the execution mask (block 428).

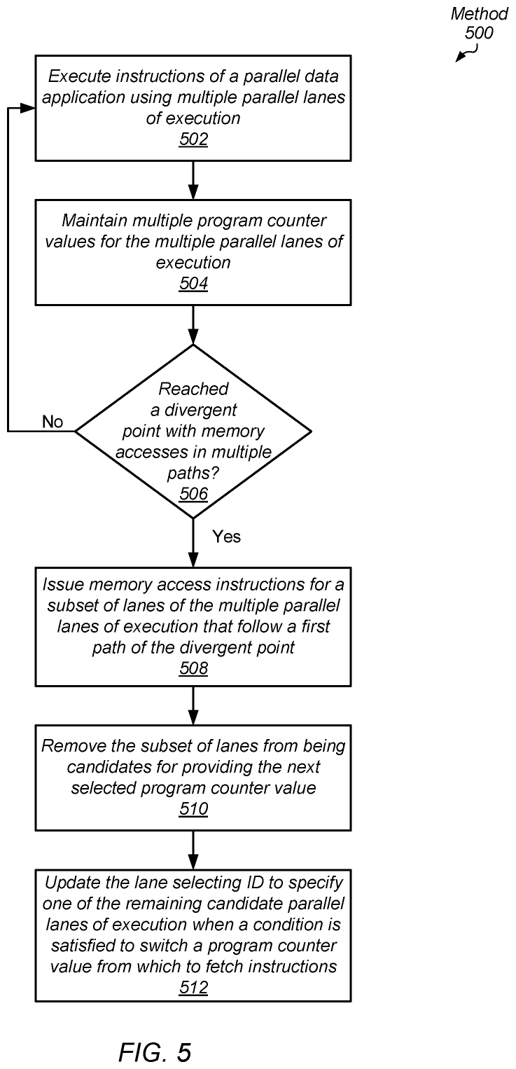

Turning now to FIG. 5, a generalized diagram is shown of a method 500 for efficiently processing instructions in hardware parallel execution lanes. A single instruction multiple data (SIMD) circuit supporting independent lane progression executes instructions of a parallel data application using multiple parallel lanes of execution (block 502). The SIMD circuit (or SIMD circuit) supporting independent lane progression maintains multiple program counter values for the multiple parallel lanes of execution (block 504). During execution of the parallel data application, it is possible that a divergent point is reached that includes an if-else construct where each of the two paths, such as the “if” path and the “else” path, includes one or more memory access instructions.

If a divergent point with memory accesses in multiple paths has not yet been reached (“no” branch of the conditional block 506), then control flow of method 500 returns to block 502 where the SIMD circuit executes instructions of the parallel data application using multiple parallel lanes of execution. However, if the divergent point with memory accesses in multiple paths has been reached (“yes” branch of the conditional block 506), then the SIMD circuit issues memory access instructions for lanes of the multiple parallel lanes of execution that follow a first path of the divergent point (block 508). For example, the SIMD circuit issues memory access instructions for a subset of lanes of the multiple parallel lanes of execution that follow the “if” path of the if-else construct.

An update control circuit of the SIMD circuit removes the subset of lanes from being candidates for providing the next selected program counter value (block 510). The update control circuit of the SIMD circuit updates the lane selecting ID to specify one of the remaining candidate parallel lanes of execution when a condition is satisfied to switch a program counter value from which to fetch instructions (block 512). In some implementations, the condition is set by steps performed in blocks 214-218 of method 200 (of FIG. 2). For example, the update control circuit measures elapsed time since reaching the divergent point. The update control circuit measures elapsed time by updating a count of clock cycles or by updating a count of instructions that have been issued or executed. When the measured elapsed time reaches a threshold, the update control circuit updates the lane number or other lane identifier stored in the lane selecting ID register. However, the update control circuit does not select any lane of the subset of lanes of the multiple parallel lanes of execution that follow the “if” path of the if-else construct.

In some implementations, each lane of this subset of lanes is executing a long-latency instruction since the memory access instruction can take hundreds of clock cycles or more to complete. The latency for the measured elapsed time to reach the threshold can be less than the latency of the long-latency instruction. By updating the program counter value sent to the instruction fetch circuit via the update control circuit, the lane selecting ID register, and the multiple program counter values for the multiple parallel lanes of execution, the SIMD circuit increases throughput. In an implementation, the update control circuit selects another subset of lanes of the multiple parallel lanes of execution that follow the “else” path of the if-else construct. This other subset of lanes can also execute long-latency instructions as the corresponding memory access instructions can also take hundreds of clock cycles or more to complete. However, these memory access instructions were issued sooner than waiting for the memory access instructions of the “if” path of the if-else construct to complete first. Additionally, even with this other subset of lanes also executing long-latency instructions, the update control circuit can still update the lane number or other lane identifier stored in the lane selecting ID register after the measured elapsed time has again reached the threshold. Therefore, any subset of lanes executing long-latency memory access instructions or other types of long-latency instructions will not stall the entire SIMD circuit. The update control circuit can still update the lane number or other lane identifier stored in the lane selecting ID register after the measured elapsed time has again reached the threshold, and consequently, other lanes of the SIMD circuit are provided an opportunity to execute and progress, rather than wait.

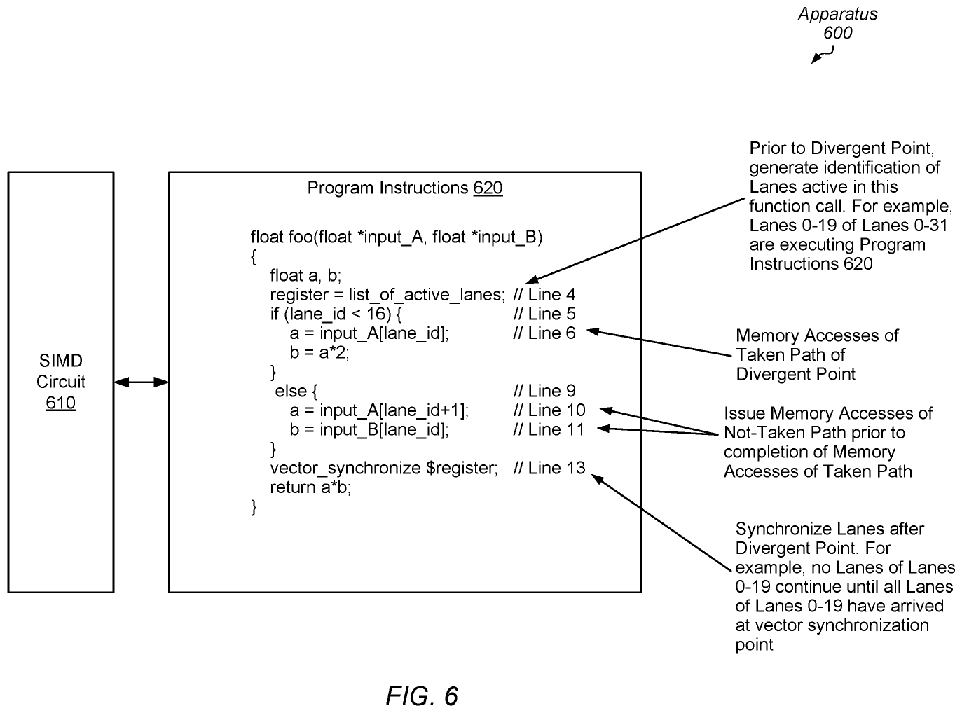

Referring to FIG. 6, a generalized diagram is shown of an apparatus 600 for efficiently processing instructions in hardware parallel execution lanes. As shown, apparatus 600 includes SIMD circuit 610 that supports independent lane progression. SIMD circuit executes a parallel data application that includes program instructions 620. In various implementations, SIMD circuit 610 has the same functionality as SIMD circuit 100 (of FIG. 1). Program instructions 620 includes a divergent point at line 5 with a branch instruction implemented by an if-else construct. Prior to the divergent point, at line 4, program instructions 620 includes an instruction that allows a developer to identify one or more lanes of multiple lanes of execution of the SIMD circuit that are executing program instructions 620. For example, program instructions 620 can be located within a nested loop and some lanes of the multiple lanes of execution did not satisfy conditions to begin executing the program instructions 620. At line 13 of program instructions 620, a vector synchronization point is provided where the SIMD circuit 610 prevents any one of multiple parallel lanes of execution executing instructions of the first path (“if” path at line 5) and the second path (“else” path at line 9) from progressing past line 13 after the divergent point at line 5 until each of the multiple parallel lanes of execution is ready to progress.

In addition, when executing memory access instructions of the first path, such as the load instruction at line 6, SIMD circuit 610 generates an indication specifying that a first latency less than a second latency of the memory access instructions of the first path has elapsed. In an implementation, SIMD circuit 610 counts the number of clock cycles that have elapsed since the load instruction was issued. When the number of clock cycles reaches a threshold number, SIMD circuit 610 executes the memory access instructions of the second path such as the load instructions at line 10 and line 11. The memory access instruction at line 6 can have a latency of hundreds or thousands of clock cycles. The threshold number of clock cycles can be less than a hundred clock cycles. Therefore, SIMD circuit 610 is able to increase throughput by concurrently executing the memory access instructions across different paths of a divergent point when no data dependency exists.

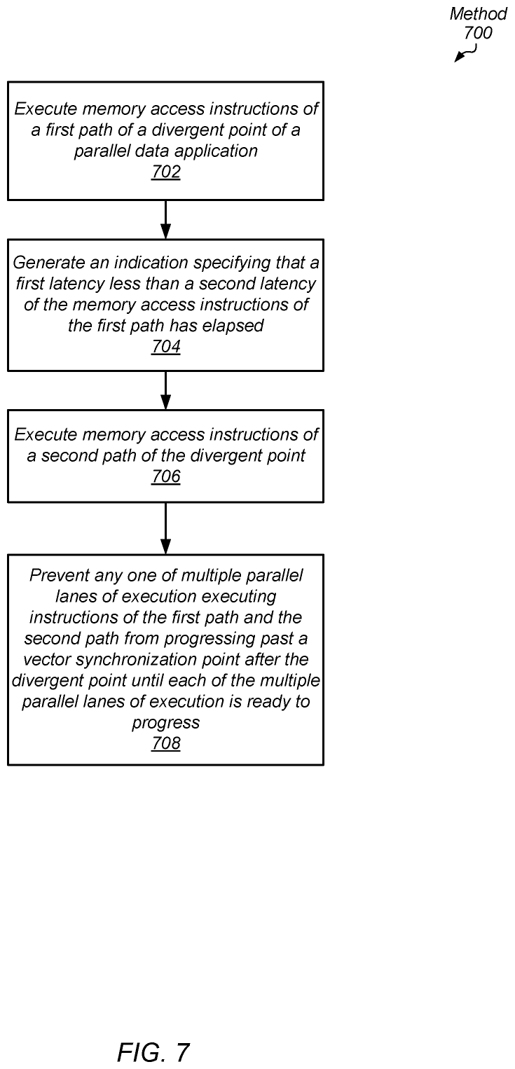

Turning now to FIG. 7, a generalized diagram is shown of a method 700 for efficiently processing instructions in hardware parallel execution lanes. A single instruction multiple data (SIMD) circuit supporting independent lane progression executes memory access instructions of a first path of a divergent point of a parallel data application (block 702). The SIMD circuit supporting independent lane progression generates an indication specifying that a first latency less than a second latency of the memory access instructions of the first path has elapsed (block 704). The SIMD circuit executes memory access instructions of a second path of the divergent point (block 706). The SIMD circuit prevents any one of multiple parallel lanes of execution executing instructions of the first path and the second path from progressing past a vector synchronization point after the divergent point until each of the multiple parallel lanes of execution is ready to progress (block 708).

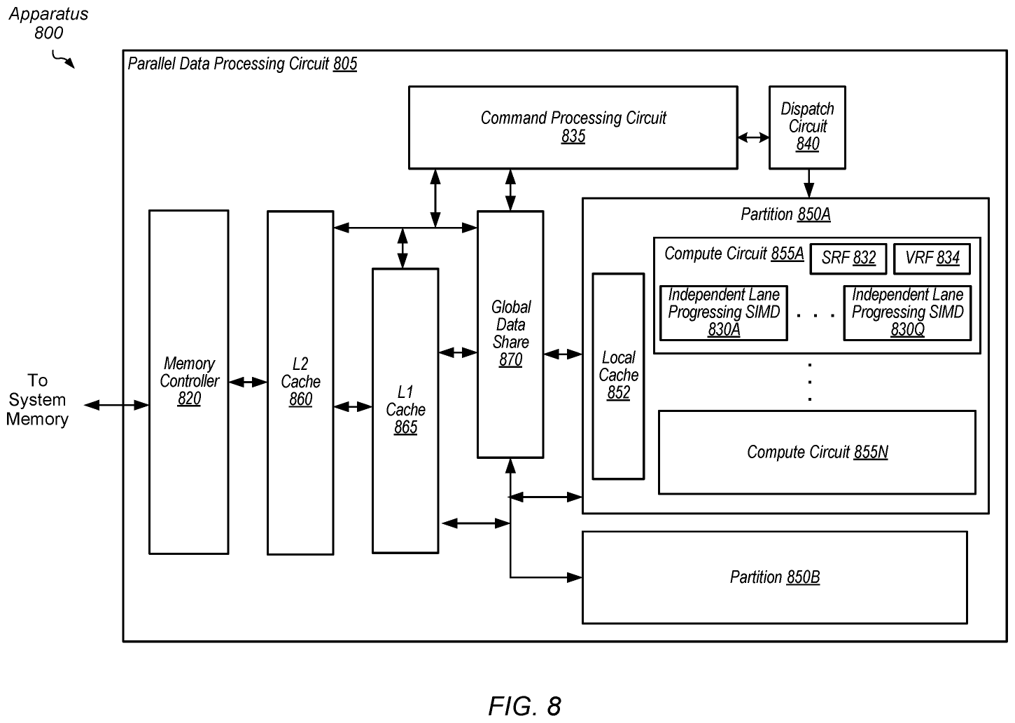

Turning now to FIG. 8, a block diagram is shown of an apparatus 800 that efficiently processing instructions in hardware parallel execution lanes. In one implementation, apparatus 800 includes the parallel data processing circuit 805 with an interface to system memory. In an implementation, the parallel data processing circuit 805 is a graphics processing unit (GPU). In various implementations, apparatus 800 executes any of various types of highly parallel data applications. As part of executing an application, a host general-purpose processing circuit, such as a central processing unit (CPU) (not shown), assigns kernels to be executed by parallel data processing circuit 805. The command processing circuit 835 receives kernels from the host CPU and determines when dispatch circuit 840 dispatches wavefronts of these kernels to the compute circuits 855A-855N.

Multiple processes of a highly parallel data application provide multiple kernels to be executed on the compute circuits 855A-855N. Each kernel corresponds to a function call of the highly parallel data application. The parallel data processing circuit 805 includes at least the command processing circuit (or command processor) 835, dispatch circuit 840, compute circuits 855A-855N, memory controller 820, global data share 870, shared level one (L1) cache 865, and level two (L2) cache 860. It should be understood that the components and connections shown for the parallel data processing circuit 805 are merely representative of one type processing circuit and does not preclude the use of other types of processing circuits for implementing the techniques presented herein. The apparatus 800 also includes other components which are not shown to avoid obscuring the figure. In other implementations, the parallel data processing circuit 805 includes other components, omits one or more of the illustrated components, has multiple instances of a component even if only one instance is shown in the apparatus 800, and/or is organized in other suitable manners. Also, each connection shown in apparatus 800 is representative of any number of connections between components. Additionally, other connections can exist between components even if these connections are not explicitly shown in apparatus 800.

In an implementation, the memory controller 820 directly communicates with each of the partitions 850A-850B and includes circuitry for supporting communication protocols and queues for storing requests and responses. Threads within wavefronts executing on compute circuits 855A-855N read data from and write data to the cache 852, vector general-purpose registers in vector register file (VRF) 834, scalar general-purpose registers scalar register file (SRF) 832, and when present, the global data share 870, the shared L1 cache 865, and the L2 cache 860. When present, it is noted that the shared L1 cache 865 can include separate structures for data and instruction caches. It is also noted that global data share 870, shared L1 cache 865, L2 cache 860, memory controller 820, system memory, and cache 852 can collectively be referred to herein as a “cache memory subsystem”.

In various implementations, the circuitry of partition 850B is a replicated instantiation of the circuitry of partition 850A. In some implementations, each of the partitions 850A-850B is a chiplet. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as a system on a chip (SoC). A first silicon wafer (or first wafer) is fabricated with multiple instantiated copies of integrated circuitry a first chiplet, and this first wafer is diced using laser cutting techniques to separate the multiple copies of the first chiplet. A second silicon wafer (or second wafer) is fabricated with multiple instantiated copies of integrated circuitry of a second chiplet, and this second wafer is diced using laser cutting techniques to separate the multiple copies of the second chiplet.

In an implementation, the local cache 852 represents a last level shared cache structure such as a local level-two (L2) cache within partition 850A. Additionally, each of the multiple compute circuits 855A-855N includes independent lane progressing SIMD circuits 830A-830Q (or SIMD circuits 830A-830Q), each with circuitry of multiple parallel computational lanes of simultaneous execution. In various implementations, each of the SIMD circuits 830A-830Q has the same functionality as SIMD circuit 100 (of FIG. 1) and SIMD circuit 610 (of FIG. 6).

One of command processing circuit 835 and control circuitry within the compute circuit 855A determines an assigned number of vector general-purpose registers (VGPRs) per thread, an assigned number of scalar general-purpose registers (SGPRs) per wavefront, and an assigned data storage space of a local data store per workgroup. Each of the compute circuits 855A-855N receives wavefronts from dispatch circuit 840 and stores the received wavefronts in a corresponding local dispatch circuit (not shown). A local scheduler within the compute circuits 855A-855N schedules these wavefronts to be dispatched from the local dispatch circuits to the SIMD circuits 830A-830Q. The cache 852 can be a last level shared cache structure of the partition 850A.

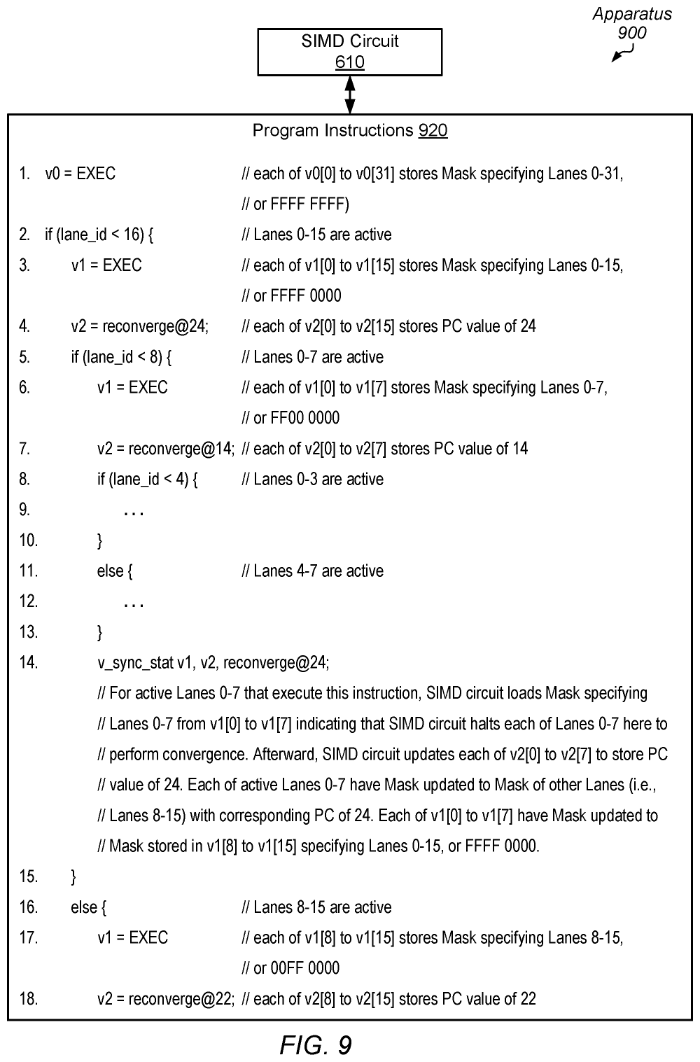

Referring to FIG. 9, a generalized diagram is shown of an apparatus 900 for efficiently processing instructions in hardware parallel execution lanes. As shown, apparatus 900 includes SIMD circuit 610 that supports independent lane progression. SIMD circuit executes a parallel data application that includes program instructions 920. In various implementations, SIMD circuit 610 has the same functionality as SIMD circuit 100 (of FIG. 1) and SIMD circuits 830A-830Q (of FIG. 8). Program instructions 920 include annotations with a numbered list to indicate line numbers of the code. Although only eighteen lines of code are shown, the parallel data application can include one or more program instructions both prior to and after program instructions 920.

At line 1 of program instructions 920, an “EXEC” instruction is used to generate and store an execution mask in the vector register 0 (v0) of the vector register file of SIMD circuit 610. The mask specifies each of the 32 parallel execution lanes of SIMD circuit 610. In an implementation, the mask includes a bit vector with a data size of 32 bits with the left-most bit corresponding to lane 0 and the right-most bit corresponding to lane 31. In an implementation, the mask includes the hexadecimal value 32h FFFF FFFF where the notation “32h” indicates a 32-bit hexadecimal value. A lane is indicated by having a corresponding bit of the 32-bit vector being asserted. In some implementations, SIMD circuit 610 includes sixteen vector registers v0 to v15. Each of these sixteen vector registers includes a sub-register or portion or subset corresponding to one of the 32 parallel execution lanes of SIMD circuit 610. Each sub-register has a size based on design requirements such as 128 bits (16 bytes), 256 bits (32 bytes), 512 bits (64 bytes), or otherwise. In other implementations, SIMD circuit 610 includes another number of vector registers in the vector register file with the number based on design requirements. When the vector register file of SIMD circuit 610 has 16 vector registers, 32 sub-registers for the 32 parallel execution lanes, and each sub-register has a size of 256 bits (32 bytes), the vector register file has a size of 16 kilobytes (KB), since 16 registers×32 sub-registers×32 bytes is 16,384 bytes.

A divergent point exists at line 2 of program instructions 920 that includes a conditional branch instruction as indicated by the IF statement. Lanes 0-15 of SIMD circuit 610 become active when the program counter (PC) equals the PC of the remaining program instructions of program instructions 920, whereas lanes 16-31 of SIMD circuit 610 become inactive. As described earlier, SIMD circuit 610 supports independent lane progression. To do so, comparator circuits 120 (of FIG. 1) of SIMD circuit 610 receive the multiple lane program counters 110A-110N and additionally receive the selected lane identifier 102. Selected lane identifier 102 stores an identifier that specifies one of the execution lanes 140A-140N. In an implementation, lane program counters 110A-110N includes 32 program counters and selected lane identifier 102 is a 5-bit value that specifies one of the 32 program counters. When the selected lane identifier 102 specifies one of the Lanes 0-15, the corresponding program counter points to at least one of the lines 2-18 of program instructions 920 when program instructions 920 have not yet completed.

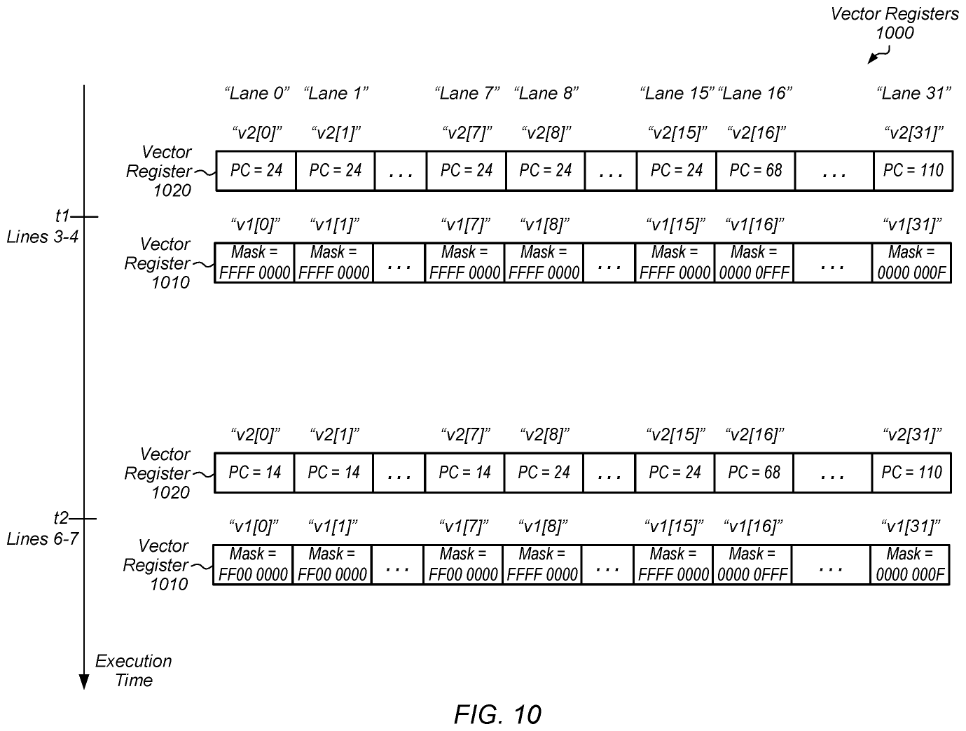

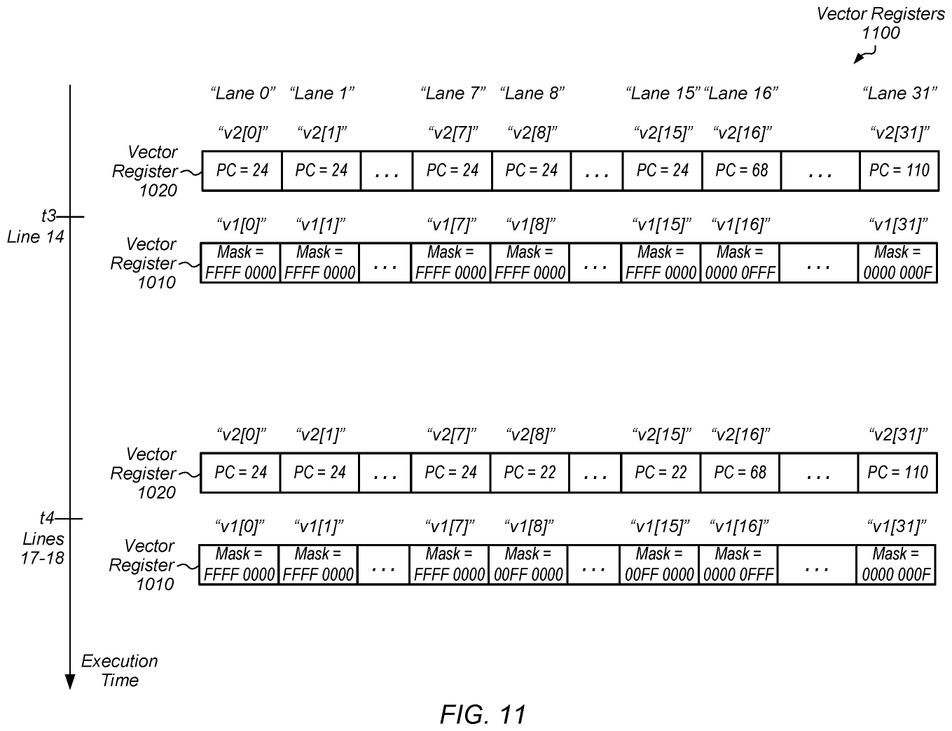

At line 3, the “EXEC” instruction causes each of the vector sub-registers v1[0] to v1[15] of the v1 vector register to store a mask specifying Lanes 0-15. In an implementation, this mask is 32h FFFF 0000. At line 4, the “reconvergence” instruction causes each of the vector sub-registers v2[0] to v2[15] of the v2 vector register to store the program counter value of 24. An illustration of the updates of contents stored in the vector registers is shown in the vector registers 1000 and 1100 (of FIGS. 10-11). Another divergent point exists at line 5 of program instructions 920 that includes a conditional branch instruction as indicated by the IF statement. Lanes 0-7 of SIMD circuit 610 become active when the program counter (PC) equals the PC of any of the program instructions between lines 5 and 15 of program instructions 920. In contrast, lanes 8-31 of SIMD circuit 610 become inactive. At line 6, the “EXEC” instruction causes each of the vector sub-registers v1[0] to v1[7] of the v1 vector register to store a mask specifying Lanes 0-7. In an implementation, this mask is 32h FF00 0000. Therefore, these vector sub-registers v1[0] to v1[7] of the v1 vector register are overwritten and no longer store the mask that was written at line 3. At line 7, the “reconvergence” instruction causes each of the vector sub-registers v2[0] to v2[7] of the v2 vector register to store the program counter value of 14. Therefore, these vector sub-registers v2[0] to v2[7] of the v2 vector register are overwritten and no longer store the program counter that was written at line 4.

Lines 8-13 include one more divergent point that adds one more nested IF loop in program instructions 920. In some implementations, the software programmer adds an “EXEC” instruction and a “reconvergence” instruction as previously illustrated. However, since this is the last nested divergent point, a later reconvergence point can be selected by the software programmer to occur at line 14. At line 14, the Lanes 0-7 execute this instruction, and load the masks stored in the vector sub-registers v1[0] to v1[7] of the v1 vector register. These masks specify Lanes 0-7, and therefore, each of the Lanes 0-7 waits to continue executing a subsequent instruction until all of the Lanes 0-7 have reached the “v_sync_stat” instruction at line 14. This waiting or prevention of continuing execution until all specified lanes are ready to continue performs reconvergence for the parallel execution.

After reconvergence occurs, the SIMD circuit updates the vector sub-registers v2[0] to v2[7] of the v2 vector register to store the program counter value of 24 specified in the instruction. Additionally, the SIMD circuit searches for sub-registers of the v1 vector register other than sub-registers v1[0] to v1[7] that have a corresponding sub-register of the v2 vector register storing the program counter of 24. For example, the sub-register v2[8] of the v2 vector register stores the program counter of 24 and the corresponding sub-register is sub-register v1[8] of the v1 vector register. The SIMD circuit updates the contents of the sub-registers v1[0] to v1[7] with the contents of the found sub-register v1[8] of the v1 vector register. Therefore, the SIMD circuit updates the contents of the sub-registers v1[0] to v1[7] with the mask specifying Lanes 0-15 such as 32h FFFF 0000.

Another divergent point exists at line 16 of program instructions 920 that includes the ELSE statement of the conditional branch instruction executed at line 5. Lanes 8-15 of SIMD circuit 610 become active when the program counter (PC) equals the PC of any of the program instructions between lines 16 and 18 of program instructions 920 as well as the immediately subsequent instructions after line 18. In contrast, lanes 0-7 and 16-31 of SIMD circuit 610 become inactive. At line 17, the “EXEC” instruction causes each of the vector sub-registers v1[8] to v1[15] of the v1 vector register to store a mask specifying Lanes 8-15. In an implementation, this mask is 32h 00FF 0000. Therefore, these vector sub-registers v1[8] to v1[15] of the v1 vector register are overwritten and no longer store the mask that was written at line 14. At line 18, the “reconvergence” instruction causes each of the vector sub-registers v2[8] to v2[15] of the v2 vector register to store the program counter value of 22. Therefore, these vector sub-registers v2[8] to v2[15] of the v2 vector register are overwritten and no longer store the program counter that was written at line 14. It is noted that only three vector registers (v0, v1, v2) are used to maintain the masks and program counter values that support reconvergence of parallel lane execution even when the program instructions include multiple nested if-else constructs.

Referring to FIG. 10, a generalized diagram is shown of vector registers 1000 for efficiently processing instructions in hardware parallel execution lanes. As described earlier, in some implementations, SIMD circuit 610 includes sixteen vector registers v0 to v15 and each of these sixteen vector registers includes a sub-register or portion or subset corresponding to one of the 32 parallel execution lanes of SIMD circuit 610. In other implementations, based on design requirements, SIMD circuit 610 includes another number of vector registers in the vector register file and includes another number of parallel execution lanes and corresponding number of vector sub-registers in the vector registers. In the implementation with 16 vector registers, two of the vector registers are shown in FIG. 10. Vector register 1010 represents vector register v1 of the vector register file and vector register 1020 represents vector register v2 of the vector register file. The contents stored in the vector registers 1010 and 1020 change over time. A timeline axis illustrating execution time and multiple points in time is shown on the left side of FIG. 10.

The point in time (or time) t1 occurs upon completion of the SIMD circuit executing lines 3-4 of program instructions 920 (of FIG. 9). As shown, each of the vector sub-registers v1[0] to v1[15] of the v1 vector register (vector register 1010) stores a mask specifying Lanes 0-15. In an implementation, this mask is 32h FFFF 0000. Each of the vector sub-registers v2[0] to v2[15] of the v2 vector register (vector register 1020) stores the program counter value of 24. Since lanes 16-31 of the parallel execution lanes of the SIMD circuit are inactive, the contents stored in each of the vector sub-registers v1[16] to v1[31] of the v1 vector register (vector register 1010) are not used and are not updated. Similarly, the contents stored in each of the vector sub-registers v2[16] to v2[31] of the v2 vector register (vector register 1020) are not used and are not updated.

The time t2 occurs upon completion of the SIMD circuit executing lines 6-7 of program instructions 920 (of FIG. 9). As shown, each of the vector sub-registers v1[0] to v1[7] of the v1 vector register (vector register 1010) stores a mask specifying Lanes 0-7. In an implementation, this mask is 32h FF00 0000. Each of the vector sub-registers v2[0] to v2[7] of the v2 vector register (vector register 1020) stores the program counter value of 12.

Referring to FIG. 11, a generalized diagram is shown of vector registers 1100 for efficiently processing instructions in hardware parallel execution lanes. Circuitry and components previously described are numbered identically. The time t3 occurs upon completion of the SIMD circuit executing the “v_sync_stat” instruction at line 14 of program instructions 920 (of FIG. 9). After reconvergence occurs, the SIMD circuit updates the vector sub-registers v2[0] to v2[7] of the v2 vector register (vector register 1020) to store the program counter value of 24 specified in the instruction. Additionally, the SIMD circuit searches for sub-registers of the v1 vector register (vector register 1010) other than sub-registers v1[0] to v1[7] that have a corresponding sub-register of the v2 vector register storing the program counter of 24. For example, the sub-register v2[8] of the v2 vector register (vector register 1020) stores the program counter of 24 and the corresponding sub-register is sub-register v1[8] of the v1 vector register (vector register 1010). The SIMD circuit updates the contents of the sub-registers v1[0] to v1[7] with the contents of the found sub-register v1[8] of the v1 vector register. Therefore, the SIMD circuit updates the contents of the sub-registers v1[0] to v1[7] with the mask specifying Lanes 0-15 such as 32h FFFF 0000.

The time t4 occurs upon completion of the SIMD circuit executing lines 17-18 of program instructions 920 (of FIG. 9). As shown, each of the vector sub-registers v1[8] to v1[15] of the v1 vector register (vector register 1010) stores a mask specifying Lanes 8-15. In an implementation, this mask is 32h 00FF 0000. Each of the vector sub-registers v2[8] to v2[15] of the v2 vector register (vector register 1020) stores the program counter value of 22. It is noted that in other implementations, separate vector registers are used other than v1 and v2 for one or more different divergent points. For example, vector registers v3 and v4 can be used for code beginning at line 5 of program instructions 920.

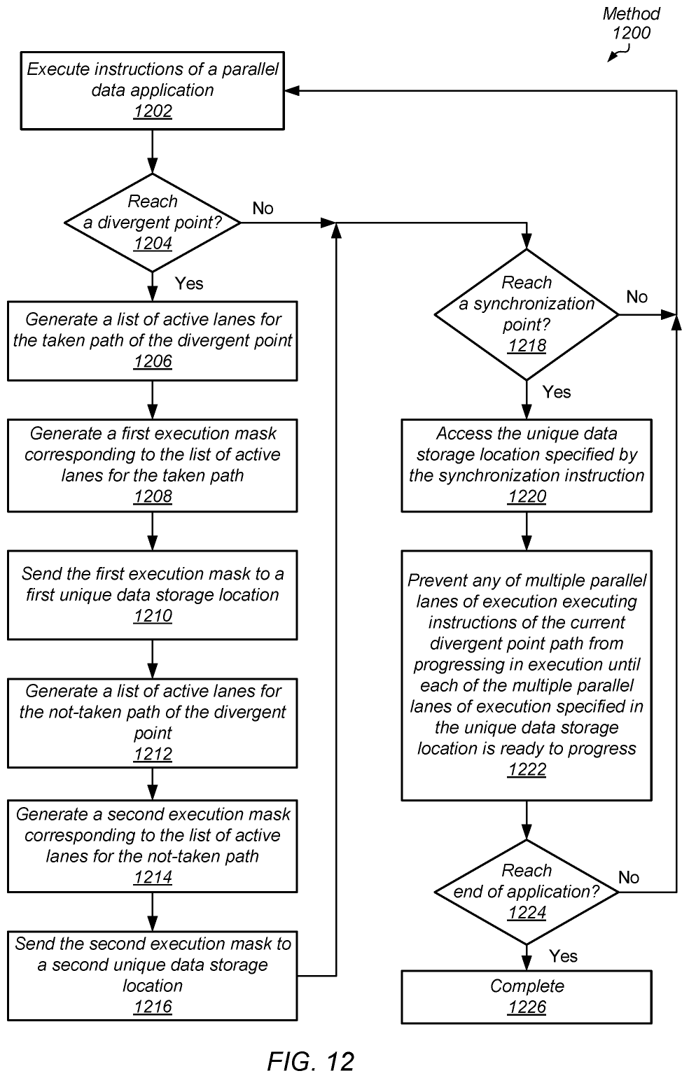

Turning now to FIG. 12, a generalized diagram is shown of a method 1200 for efficiently processing instructions in hardware parallel execution lanes. A single instruction multiple data (SIMD) circuit supporting independent lane progression executes instructions of a parallel data application (block 1202). In some implementations, the SIMD circuit has the same functionality as SIMD circuit 100 (of FIG. 1), the SIMD circuit 610 (of FIG. 6 and FIG. 9), and SIMD circuits 830A-830Q (of FIG. 8). In various implementations, the SIMD circuit performs one or more steps previously described in the descriptions of methods 200, 400-500 and 700 (of FIGS. 2, 4-5 and 7). As described earlier, examples of the divergent point (conditional control flow transfer instruction) are a conditional branch instruction and a conditional case statement. The software programmer inserts a divergent point at the end of a basic block of the parallel data application (or application) to conditionally transfer control flow to additional instructions in a separate basic block located elsewhere in the application before transferring control to the next subsequent basic block. If the SIMD circuit has not yet reached a divergent point by executing a conditional control flow transfer instruction in the application (“no” branch of the conditional block 1204), and the SIMD circuit has not yet reached a synchronization point by executing a synchronizing instruction (“no” branch of the conditional block 1218), and then control flow of method 1200 returns to block 1202 where the SIMD circuit executes instructions of the parallel data application.

If the SIMD circuit has reached a divergent point by executing a conditional control flow transfer instruction in the application (“yes” branch of the conditional block 1204), then the SIMD circuit generates a list of active lanes of the parallel execution lanes of the SIMD circuit for the taken path of the divergent point (block 1206). The SIMD circuit generates a first execution mask corresponding to the list of active lanes for the taken path (block 1208). In an implementation, the list of active lanes for the taken path of the divergent point includes the even numbered lanes of the parallel execution lanes of the SIMD circuit. In another implementation, the list of active lanes for the taken path of the divergent point includes lanes of the parallel execution lanes with lane identifiers less than a threshold lane identifier. In yet other implementations, the list of active lanes for the taken path of the divergent point includes a more complex list such as lanes of the parallel execution lanes with lane identifiers equal to 0, 2-7, 11, 112 and 21-31. In an implementation, the first execution mask includes a number of bits equal to the number of parallel execution lanes of the SIMD circuit and includes an asserted bit for each bit position corresponding to the list of active lanes for the taken path of the divergent point.

The SIMD circuit sends the first execution mask to a first unique data storage location (block 1210). In some implementations, the first unique data storage location is a particular portion or sub-register of a particular vector register of the vector register file. In an implementation, the SIMD circuit includes The SIMD circuit generates a list of active lanes for the not-taken path of the divergent point (block 1212). The SIMD circuit generates a second execution mask corresponding to the list of active lanes for the not-taken path (block 1214). The SIMD circuit sends the second execution mask to an identified second unique data storage location (block 1216). In some implementations, the SIMD circuit skips performing the steps of blocks 1212-1216 and waits to generate the mask corresponding to the list of active lanes for the not-taken path until the program instructions of the not-taken path have begun execution. Afterward, control flow of method 1200 moves to conditional block 1218.

If the SIMD circuit has reached a synchronization point by executing a synchronizing instruction (“yes” branch of the conditional block 1218), then the SIMD circuit accesses the unique data storage location specified by the synchronization instruction (block 1220). The SIMD circuit prevents any of multiple parallel lanes of execution executing instructions of the current divergent point path from progressing in execution until each of the multiple parallel lanes of execution specified in the unique data storage location is ready to progress (block 1222). In some implementations, the SIMD circuit performs the steps described earlier for line 14 of program instructions 920 (of FIG. 9). If the SIMD circuit has not yet reached the end of the application (“no” branch of the conditional block 1224), then control flow of method 1200 returns to block 1202 where the SIMD circuit executes instructions of the parallel data application. If the SIMD circuit has reached the end of the application (“yes” branch of the conditional block 1224), then the SIMD circuit completes executing the application (block 1226).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A processor comprising:
circuitry configured to:
maintain a plurality of program counter values for a plurality of parallel lanes of execution;
generate a first indication specifying a taken path of a plurality of paths of execution during execution of a parallel data application by the plurality of parallel lanes of execution, responsive to reaching a divergent point;
generate a lane selecting identifier (ID) specifying a first parallel lane of execution of the plurality of parallel lanes of execution that remains active to execute the taken path; and
continue execution by one or more of the plurality of parallel lanes of execution, responsive to the one or more of the plurality of parallel lanes of execution having a program counter value that matches the program counter value of the first parallel lane of execution.

2. The processor as recited in claim 1, wherein the circuitry is further configured to generate a second indication specifying a trap or an interrupt has occurred.

3. The processor as recited in claim 2, wherein the circuitry is further configured to update the plurality of program counter values stored in a vector register file, responsive to one or more of the divergent point has been reached and the second indication has been generated.

4. The processor as recited in claim 2, wherein the circuitry is further configured to update the lane selecting ID to specify a second parallel lane of execution of the plurality of parallel lanes of execution that has remained inactive.

5. The processor as recited in claim 4, wherein the circuitry is further configured to continue executing each of the plurality of parallel lanes of execution with a corresponding one of the plurality of program counter values that matches a program counter value of the second parallel lane of execution.

6. The processor as recited in claim 1, wherein the circuitry is further configured to issue memory access instructions corresponding to a first path of an if-else construct prior to memory access instructions already issued for a second path of the if-else construct have completed.

7. The processor as recited in claim 1, wherein responsive to reaching the divergent point, the circuitry is further configured to store in:
a first vector register of a vector register file a mask specifying one or more lanes of the plurality of parallel lanes of execution to prevent from progressing past a vector synchronization point after the divergent point; and
a second vector register of the vector register file a program counter value specifying a vector synchronization point for the one or more lanes of the plurality of parallel lanes of execution specified by the mask.

8. A method, comprising:
maintaining, by circuitry, a plurality of program counter values for a plurality of parallel lanes of execution;
generating, by the circuitry, a first indication specifying a taken path of a plurality of paths of execution during execution of a parallel data application by the plurality of parallel lanes of execution, responsive to reaching a divergent point;
generating, by the circuitry, a lane selecting identifier (ID) specifying a first parallel lane of execution of the plurality of parallel lanes of execution that remains active to execute the taken path; and
continuing execution by one or more of the plurality of parallel lanes of execution, responsive to the one or more of the plurality of parallel lanes of execution having a program counter value that matches the program counter value of the first parallel lane of execution.

9. The method as recited in claim 8, further comprising generating, by the circuitry, a second indication specifying a wait instruction has been executed.

10. The method as recited in claim 9, further comprising updating the plurality of program counter values stored in a vector register file, responsive to one or more of the divergent point has been reached and the second indication has been generated.

11. The method as recited in claim 9, further comprising updating, by the circuitry, the lane selecting ID to specify a second parallel lane of execution of the plurality of parallel lanes of execution that has remained inactive.

12. The method as recited in claim 11, further comprising continuing executing each of the plurality of parallel lanes of execution with a corresponding one of the plurality of program counter values that matches a program counter value of the second parallel lane of execution.

13. The method as recited in claim 8, further comprising issuing memory access instructions corresponding to a first path of an if-else construct prior to memory access instructions already issued for a second path of the if-else construct have completed.

14. The method as recited in claim 13, further comprising preventing one of the plurality of parallel lanes of execution executing instructions of the first path and the second path from progressing past a vector synchronization point after the divergent point until each of the plurality of parallel lanes of execution is ready to progress.

15. A computing system comprising:
a memory configured to store program instructions; and
circuitry configured to:
maintain a plurality of program counter values for a plurality of parallel lanes of execution;
generate a first indication specifying a taken path of a plurality of paths provided by a divergent point in a parallel data application, responsive to reaching the divergent point during execution of the program instructions;
generate a lane selecting identifier (ID) specifying a first parallel lane of execution of the plurality of parallel lanes of execution that remains active to execute the taken path; and
continue execution by one or more of the plurality of parallel lanes of execution, responsive to the one or more of the plurality of parallel lanes of execution having a program counter value that matches the program counter value of the first parallel lane of execution.

16. The computing system as recited in claim 15, wherein the circuitry is further configured to generate a second indication specifying a threshold period of time has elapsed since the divergent point has been reached.

17. The computing system as recited in claim 16, wherein the circuitry is further configured to update the plurality of program counter values stored in the plurality of program counter values of a vector register file, responsive to one or more of the divergent point has been reached and the second indication has been generated.

18. The computing system as recited in claim 16, wherein the circuitry is further configured to update the lane selecting ID to specify a second parallel lane of execution of the plurality of parallel lanes of execution that has remained inactive.

19. The computing system as recited in claim 18, wherein the circuitry is further configured to continue executing each of the plurality of parallel lanes of execution with a corresponding one of the plurality of program counter values that matches a program counter value of the second parallel lane of execution.

20. The computing system as recited in claim 15, wherein the circuitry is further configured to issue memory access instructions corresponding to a first path of an if-else construct prior to memory access instructions already issued for a second path of the if-else construct have completed.
